(19) United States
(12) Patent Application Publication
(10) Pub. No.: US 2015/0107953 A1
(43) Pub. Date: Apr. 23, 2015

(54) Eccentric Lock One Way Clutch

(71) Applicant: Jeffrey M. Lucas, Hopkins, MN (US)

(72) Inventor: Jeffrey M. Lucas, Hopkins, MN (US)

(21) Appl. No.: 14/481,489

(22) Filed: Sep. 9, 2014

Related U.S. Application Data
(60) Provisional application No. 61/894,487, filed on Oct. 23, 2013.

(51) Int. Cl. F16D 41/06

(52) U.S. Cl. CPC F16D 41/06
USPC 192/46

(57) ABSTRACT

By way of surface contact between a segmented race and a non-segmented race and using wedge-like locking forces to fix the eccentricity of the segmented race, a Surface Contact One Way Clutch (SC1C) actively drives a second race in a single direction and at a fixed speed relative to the first race unless the speed of the second race exceeds that of the first race in the single direction in which case the second race is free to “overrun” or passively exceed the speed of the first race.

### CROSS REFERENCE TO RELATED APPLICATIONS

This application claims the benefit of provisional application Ser. No. 61/894,487, filed Oct. 23, 2014, which application is incorporated herein by reference in its entirety.

### SUMMARY

The present disclosure relates to a one way clutch wherein unidirectional wedge-like locking forces are used to fix in place an eccentric segmented race relative to a fixed eccentric non-segmented race so that one of the races drives the other race at the same speed in a single direction until such point that the speed of the driven race exceeds (or overruns) the speed of the driving race in that same direction, and the lockup of the two races occurs with very little to no backlash when changing from overrunning to interlocked. The primary advantage of the Surface Contact One Way Clutch (SC1C), over other types of one way clutches with zero backlash lockup (for example, sprag clutches or roller ramp clutches) is that power transmission between the two races takes place over contacting surfaces, as opposed to isolated lines of contact. As a result, compared to sprag type clutches and roller ramp type clutches, the Surface Contact One Way Clutch (SC1C) has significantly higher product life and is much better suited to high speed indexing applications.

### BRIEF DESCRIPTION OF THE DRAWINGS

FIGS. 1 and 2 illustrate the design and operation of a first example embodiment. This embodiment uses an inner segmented eccentric race attached to acutely-angled linkages that when forced to rotate clockwise from the pins near the center axis, the race segments rub against the outer race creating strong wedge-like forces that fix in place the eccentric circular shape of the inner segmented eccentric race in order to drive an outer non-segmented eccentric race. If the outer race is used as the driving component, it will likewise interlock with the inner race as the outer race is rotated counterclockwise.

FIG. 3 illustrates a means for eliminating side loads in the first example embodiment by using two sets of races offset 180 degrees. Because the eccentric design creates forces that push to one side as torque is applied, using two sets of races offset 180 degrees will counterbalance the side forces in such a way as to eliminate them.

FIGS. 4 and 5 illustrate the design and operation of a second example embodiment. This embodiment uses an outer segmented eccentric race attached to acutely angled linkages that when forced to rotate counterclockwise from the pins farthest out from the center axis, the race segments rub against the inner race creating strong wedge-like forces that fix in place the eccentric circular shape of the outer segmented eccentric race in order to drive an inner non-segmented eccentric race. If the inner race is used as the driving component, it will likewise interlock with the outer race as the inner race is rotated clockwise.

### DETAILED DESCRIPTION

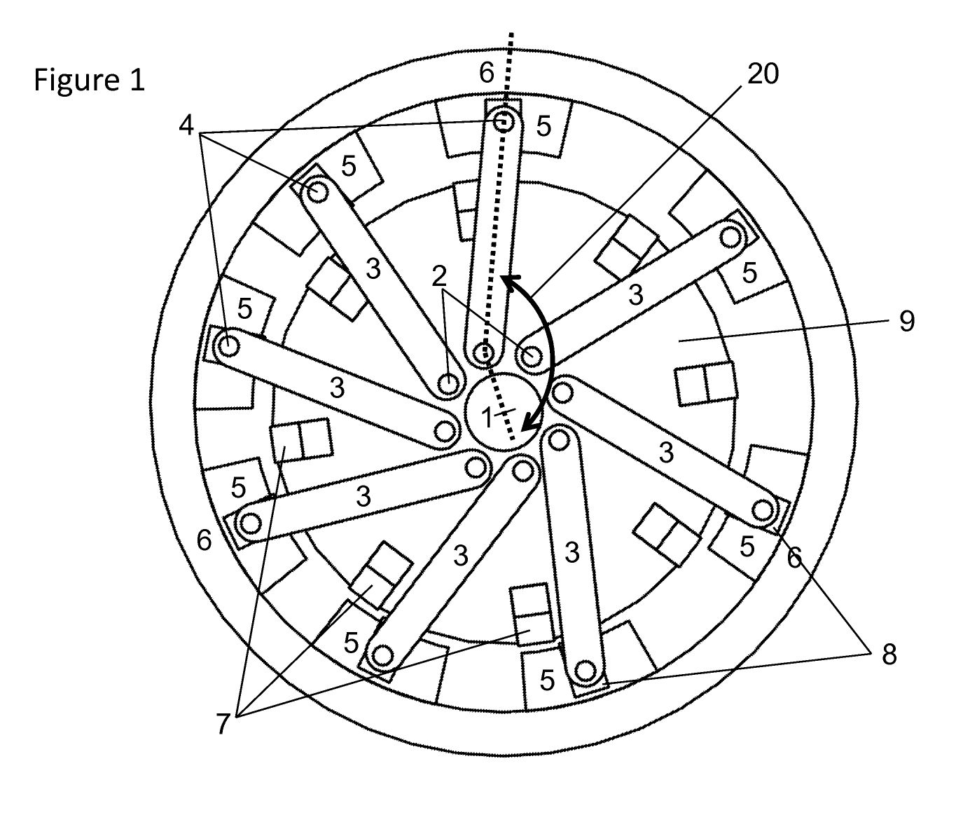

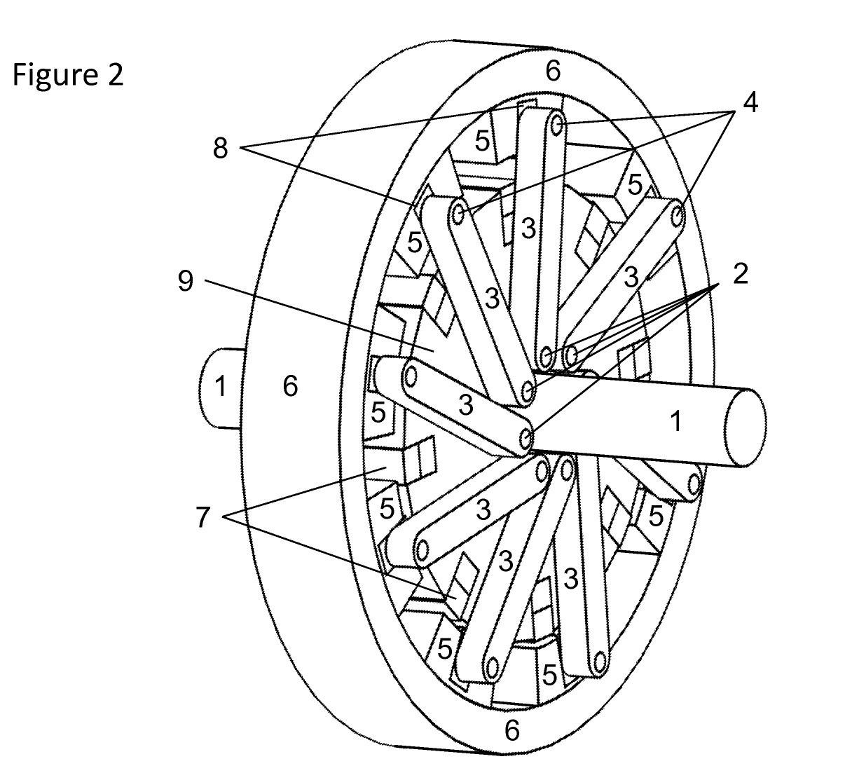

FIG. 1 shows a straight axial plan view, and FIG. 2 shows a perspective view of the first example embodiment of the present disclosure. Although the torque flow through the embodiments can be from inner components outward or outer components inward for either of the embodiments shown and described, the most common torque flow through the first embodiment would be from the inner components outward. Input shaft 1 drives first input pins 2 since both input shaft 1 and first input pins 2 are solidly connected to each other through a drive cylinder 9. First input pins 2 drive linkages 3 in a pivoting manner about each axes of first input pins 2 since the drag from the blocks of inner segmented eccentric race 5 as they rub against outer non-segmented eccentric race 6 creates counterclockwise torque about each axes of first input pins 2 as input shaft 1 is rotated clockwise. Second input pins 4 provide an axis around which the blocks of inner segmented eccentric race 5 can pivot so that the outer surfaces of inner segmented eccentric race 5 can stay perfectly mated with the inner surface of outer non-segmented eccentric race 6.

The acute angle 20 of linkages 3 relative to the radial trajectory of the input axis of input shaft 1 is extreme enough so as to create tremendous wedge-like forces that push the blocks of inner segmented eccentric race 5 outward against outer non-segmented eccentric race 6, locking the blocks against any tendency to move back inward. With the blocks of inner segmented eccentric race 5 locked against outer non-segmented eccentric race 6 in this way, all components 1 through 5 are prevented from turning clockwise without turning outer non-segmented eccentric race 6 along with them.

The eccentricity of inner segmented eccentric race 5 and outer non-segmented eccentric race 6 creates a relationship that works to interlock the two components well beyond what would be present with static friction alone. If the two races were not eccentric, the static friction forces necessary to interlock them would be extremely great because the contact between them is over significant surface areas as opposed to lines of contact. However, by making the races eccentric, the outward force necessary to interlock them only needs to be greater than the tendency of the blocks of inner segmented eccentric race 5 to be forced back inward by the movement of these blocks from a longer radial distance position along outer non-segmented eccentric race 6 to a shorter radial distance position along outer non-segmented eccentric race 6. The wedging forces of the Surface Contact One Way Clutch (SC1C) simply serve to fix the blocks of inner segmented eccentric race 5 in an eccentric position that interlocks with outer non-segmented eccentric race 6 much like a rigidly fixed eccentric cylinder inside a tightly fitted, rigidly fixed eccentric cylindrical cavity. Not relying on static friction alone, the outward forces necessary to lock the SC1C races together are likely even less than the outward forces needed to interlock the races of sprag type clutches or roller ramp type clutches.

A backpressure-creating mechanism, which is common to sprag type clutches and roller ramp type clutches, is used to keep the blocks of inner segmented eccentric race 5 near or against outer non-segmented eccentric race 6. All drawings, FIG. 1 through FIG. 5, illustrate the use of magnets as a backpressure-creating mechanism. In FIG. 1 through FIG. 3, drive-loaded magnets 7 are attached to drive cylinder 9, and race-loaded magnets 8 are attached to the blocks of inner segmented eccentric race 5. By positioning the fields of these magnets appropriately, backpressure forces can be applied to the blocks of inner segmented eccentric race 5 so that the blocks are pushed near or against outer non-segmented eccentric race 6. Keeping the races near or against each other in this way provides an immediate interlocking of the races when input shaft 1 is turned clockwise relative to outer non-segmented eccentric race 6. When input shaft 1 is turned counterclockwise relative to outer non-segmented eccentric race 6, then the wedging forces are not present and outer non-segmented eccentric race 6 can freely rotate clockwise relative to input shaft 1. When the races are allowed to overrun in this manner, the backpressure-creating mechanism, drive-loaded magnets 7 and race-loaded magnets 8, still keeps the blocks of inner segmented eccentric race 5 pushed near or against outer non-segmented eccentric race 6, so that when the relative rotation between these two races is reversed, the interlocking of the races is immediate.

Although magnets are used to illustrate the backpressure-creating mechanism within the figures shown, it is within the scope of the invention to use other backpressure-creating mechanisms with the SC1C device; for example, using metal springs like those common to sprag type clutches or roller ramp type clutches.

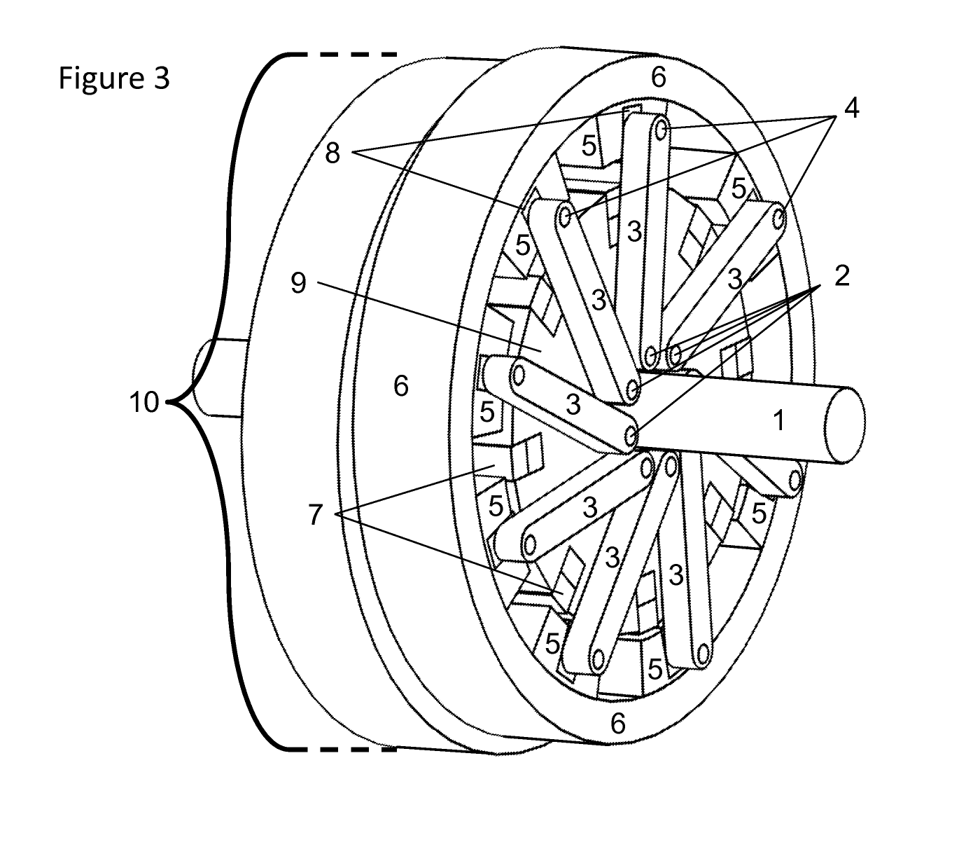

FIG. 3 shows a perspective view of a first example embodiment wherein the forces are balanced by a second set of eccentric races 10, which are offset from the first set of eccentric race components (inner segmented eccentric race 5 and outer non-segmented eccentric race 6) by 180 degrees. Because the eccentricity of the races creates forces that push to one side as torque is applied to input shaft 1, a second set of eccentric races 10 can be added and offset 180 degrees to counterbalance the side forces in such a way as to eliminate them.

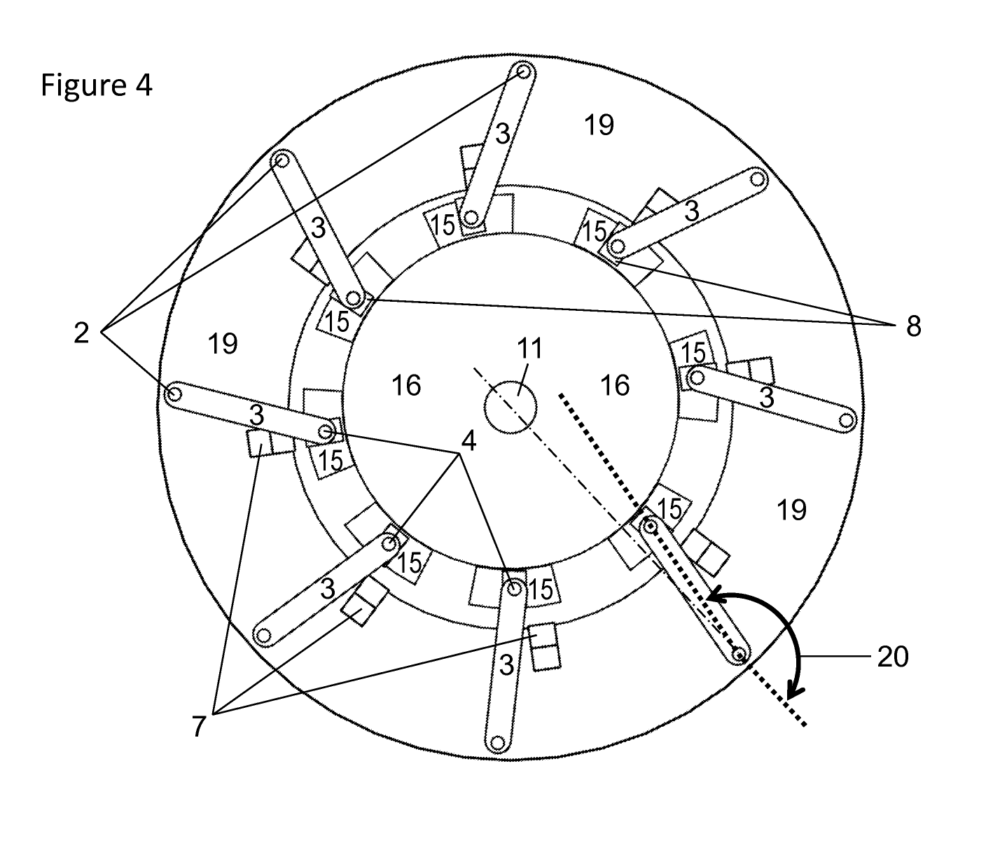

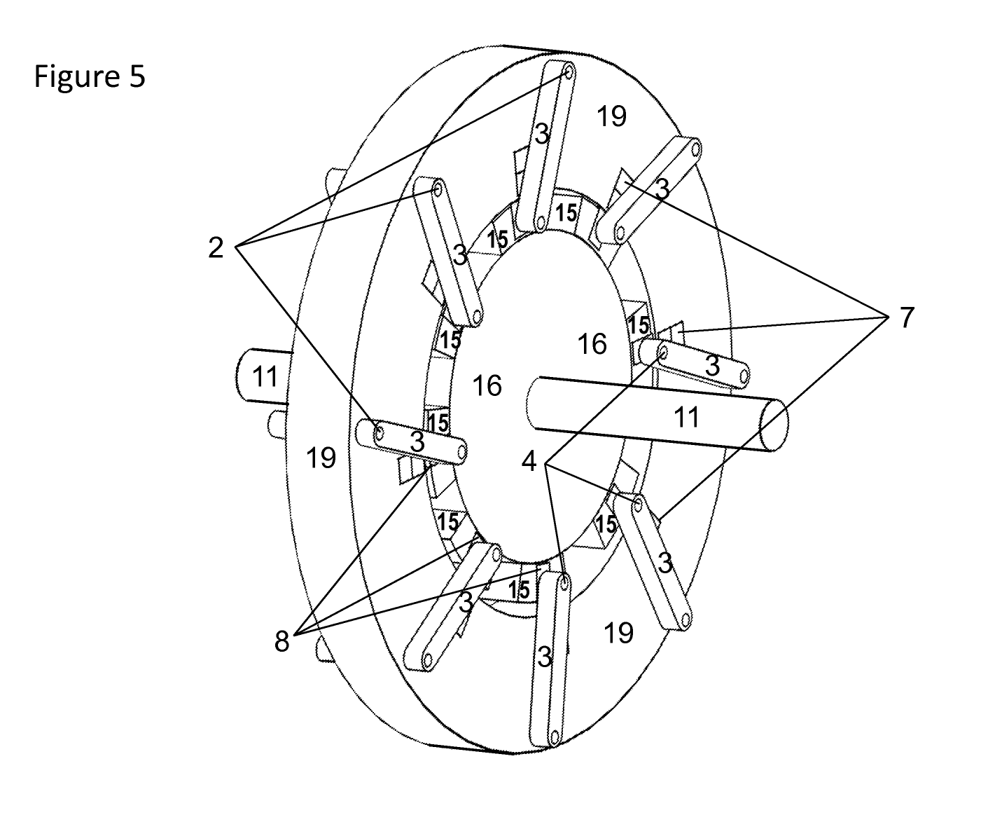

FIG. 4 shows a straight axial plan view, and FIG. 5 shows a perspective view of a second example embodiment of the present disclosure. The second example embodiment has similar components as the first example embodiment and functions in a similar manner. The second example embodiment differs from the first example embodiment primarily in that the positions of the races have been switched. The segmented eccentric race is now on the outside (i.e., outer segmented eccentric race 15) and the non-segmented eccentric race is now on the inside (i.e., inner non-segmented eccentric race 16); and drive cylinder 9, which was on the inside, has been replaced with drive tube 19, which is on the outside. Additionally, input shaft 1 from first example embodiment has been replaced by output shaft 11 in the second example embodiment.

Although the torque flow through the embodiments can be from inner components outward or outer components inward for either embodiment, the most common torque flow through the second embodiment would be opposite that most common to the first example embodiment. Initial torque would be applied to drive tube 19, which would apply force to linkages 3 by way of first input pins 2, which would apply force to outer segmented eccentric race 15 by way of second input pins 4, which would engage inner non-segmented eccentric race 16, which would drive output shaft 11.

1. A unidirectional torque transmitting device comprising:
a torque-initiating member to which torque is initially applied and transferred to a radial-force-producing mechanism that converts unidirectional torque to radial forces that serve to lock the torque-initiating member to a final torque transmission member by way of a rotation-interlocking eccentric configuration when the relative rotational speeds of engagement members match up with the unidirectional nature of torque transmission within the system.

2. The unidirectional torque transmitting device of claim 1, wherein surface contact between engagement members is used to lock the torque-initiating member to the final torque transmission member.

3. The unidirectional torque transmitting device of claim 2, wherein an orientation-adjustment mechanism is used to maintain alignment between engagement member contact surfaces.

4. The unidirectional torque transmitting device of claim 1, wherein lines of contact between engagement members are used to lock the torque-initiating member to the final torque transmission member.

5. The unidirectional torque transmitting device of claim 4, wherein an orientation-adjustment mechanism is used to maintain alignment between engagement member contact lines.

6. The unidirectional torque transmitting device of claim 1, wherein a backpressure-creating mechanism is used to keep engagement members near or against each other regardless of engagement member speeds or directions of rotation.

7. The unidirectional torque transmitting device of claim 1, wherein the eccentricity of the device is mirrored with a complimentary set of components so as to balance side loads produced by the radial-force-producing mechanism.
